(19) United States
(12) Patent Application Publication
(10) Pub. No.: US 2002/0069138 A1
(43) Pub. Date: Jun. 6, 2002

(54) Method and system for delivering art information by use of a telecommunication path

(76) Inventor: Yoshimasa Horibe, Tokyo (JP)

Correspondence Address: WELLS ST. JOHN P.S., 601 W. FIRST, SUITE 1300, SPOKANE, WA, 99201-3828, US

(21) Appl. No.: 09/952,892

(22) Filed: Sep. 11, 2001

(30) Foreign Application Priority Data
Dec. 6, 2000 (JP) 2000-371316

(51) Int. Cl. G06F 17/60

(52) U.S. Cl. 705/27

(57) ABSTRACT

A method and system for facilitating acquisition of art information is provided. Art information, including rental photos, game software, and so forth, is posted on a home page, and the information is delivered via a telecommunication path in response to a download request from a user who has been registered. The number of downloads is counted by a counter associated with art information, and an information service fee is paid to the provider of the art information according to the number of downloading operations.

### TECHNICAL FIELD

The present invention relates to methods and systems for delivering art information via a telecommunication path, said art information comprising digitized still-image information, motion-image information, sound information, illustration information, computer software including game software, and any combination thereof, and, more specifically, to methods and systems for counting the number of downloads for the art information requested and paying a predetermined service fee, based on the number of downloads, to an owner of said art information.

### BACKGROUND OF THE INVENTION

Design and production houses create designs along the following process in response to a request for design creation. First, the production house considers an overall sketch of a design that complies with the intention of a client. As a result of this consideration, it may be possible to create a design desired by the client by use of existing designs, unless a wholly new design is to be created. As a way for utilizing existing designs, a method, called rental photo service, may be simply employed. This method provides a service by which a rental photo provider collects photos and designs (called “rental photos”) from photographers and designers and delivers rental photo catalogs contained in photo collection books or compact discs to design houses and production companies. Rental photos cover a whole gamut of objects, including: natural objects, such as landscapes; vegetation, such as plants and fruits; animals, such as birds and beasts; and structures, such as buildings and bridges, and they are handled as clip art. Because photos and other materials contained in rental photo catalogs are used for design prototyping, their resolutions are lower than those used eventually.

A designer at the production company chooses desired photos from the rental photo catalogs contained in the distributed photo collections, and combines them with his or her original design, in some cases, to create a prototype design. The resulting prototype design is presented to the client, and once a design expected by the client is finished, the process proceeds to the production of the final design. The designer obtains from the rental photo provider, with some fee, high-resolution versions of the rental photos selected, and place them into the prototype design to complete the final design.

Rental photos mentioned above are typically contained in photo catalogs, and the types of rental photos contained, whether they are in the form of a book or a CD-ROM, are limited. Even though the photos and other materials contained in the photo catalog are low-resolution versions for use in design prototyping, use of such rental photos in the final production will incur a service fee due to copyrights and so on. Furthermore, because the photo catalogs might not be revised frequently, it would be difficult to obtain rental photos needed by the designer.

Accordingly, the present invention is intended to solve the above-mentioned problems, and a method for delivering art information by use of a telecommunication path according to the present invention comprises the steps of: storing digitized art information in a predetermined area of a computer; in response to a request for downloading said art information from said computer via a telecommunication path, counting the number of said download requests as a count value by a counter associated with said art information; and calculating a service fee for said art information, based on said count value.

### SUMMARY OF THE INVENTION

A system for delivering art information via a telecommunication path according to the present invention comprises: a memory area for storing in a predetermined area of a computer connected to said telecommunication path, said art information delivered from an owner of said art information; a transmission control portion for transmitting onto said telecommunication path said art information stored in said memory area, in response to a request for downloading said art information; a counter having a predetermined association with said art information stored in said memory area and counting the number of requests for downloading said art information; and a calculating portion for calculating a service fee to be paid to said owner, based on the count value indicated by said counter.

So configured, the present invention provides a method for delivering rental photos by use of a telecommunication path and a system for implementing it.

More specifically, the present invention stores rental photos in a host computer connected to a telecommunication path and, in response to an access from a user, presents rental photos on the computer of the user.

The present invention also permits rental photos presented on the computer of the user to be selected so that desired rental photo may be downloaded from the host computer in response to a request of the user.

Furthermore, the present invention permits rental photos to be swapped as appropriate, because rental photos are stored in the host computer.

The present invention also allows the number of rental photo downloads to be counted by providing in the host computer a counter associated with rental photos.

An embodiment of the present invention is described below with reference to the drawings.

### BRIEF DESCRIPTION OF THE DRAWINGS

Preferred embodiments of the invention are described below with reference to the following accompanying drawings.

FIG. 1 shows an overall schematic view for describing the system environment where the present invention is implemented;

FIG. 2 shows rental photos displayed on a screen of a client computer;

FIG. 3 is a diagram for describing the relationship between the rental photo and its associated counter;

FIG. 4 shows a block diagram for implementing the present invention in the server; and

FIG. 5 shows a flow chart for describing the method for delivering art information according to the present invention.

### DETAILED DESCRIPTION OF THE DRAWINGS

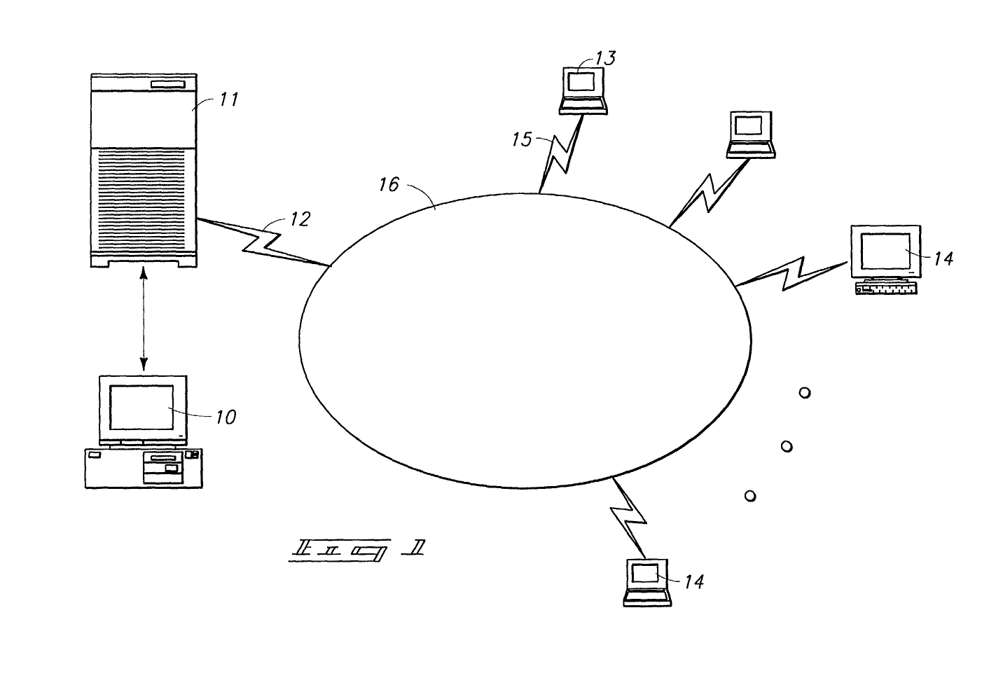

FIG. 1 is an overall schematic view for describing the system environment where the present invention is implemented. A host computer 10 is coupled to a server 11 and is used for administration of the system according to the present invention. More specifically, it is used as a terminal for entry of various kinds of art information, and it accepts download requests from the user of art information and manages transmissions thereof. In FIG. 1, the host computer 10 and server 11 are shown as separate units, although the host computer 10 may have the server capability. The server 11 stores various kinds of information transferred from the host computer 10, especially stores art information in a predetermined format. The server 11 exchanges art information with client computers 13 and 14 via a telecommunication path 12, although the client computer 13 and 14 may dial up for direct connection to the server 11 via a telecommunication path 15, or may use the Internet or i-mode service offered by NTT DoCoMo for connection thereto. Furthermore, connections of the server 11 and client computers 13 and 14 with the telecommunication paths 12 and 15 may be wired or wireless paths, such as, for example, television broadcast lines, cable TV lines, or even digital interactive television lines. FIG. 1 shows a case where the server 11 and client computers 13 and 14 are interconnected via the Internet 16.

Digitized art information stored in the server 11 is not restricted by its content but include any kind of information, and may comprise still images, motion images, sound information, any combination thereof, or game software containing control programs incorporating still images, motion images, and sound information. Such art information is input by the system operator, from the host computer 10 to the server 11, and, in response to a request of a user, downloaded to the client computers 13 and 14 via the Internet 16.

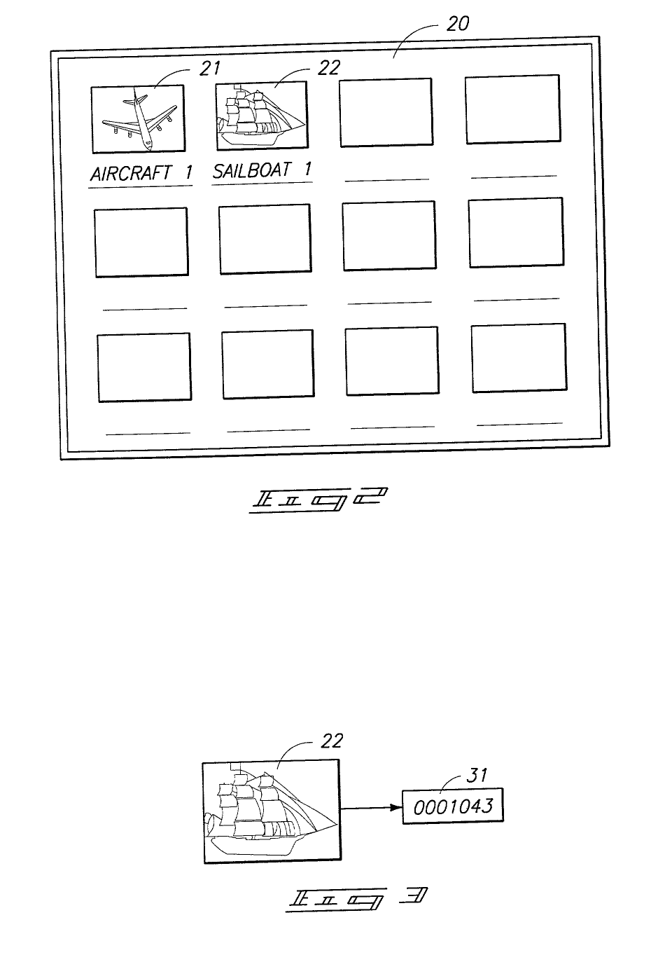

Now, the procedures of how the user downloads art information form the server 11 by use of the client computer 13 and 14 are described. The user who wants to receive the delivery of art information first accesses the home page operated by the system operator and opens a page where the user can view the list of art information desired. This page organize the art information according to the category; for example, if one wants to browse still pictures of vehicles, one may click a certain letter(s) or button to jump to a page that lists art information regarding vehicles. For example, as shown in FIG. 2, an image 20 that is enough to recognize the overview or category of the art information is displayed as a thumbnail or icon on the computer screen. In FIG. 2, a rental photo (aircraft) 21 and a rental photo (sailboat) 22 are shown by way of example. Here, the user selects desired art information from those images. If he wants the art information related to the sailboat 22, downloading is initiated by clicking the image or letters of the sailboat 22. The user may also be allowed to search desired art information by keyword. In that case, it is necessary to assign a keyword to each piece or category of the art information.

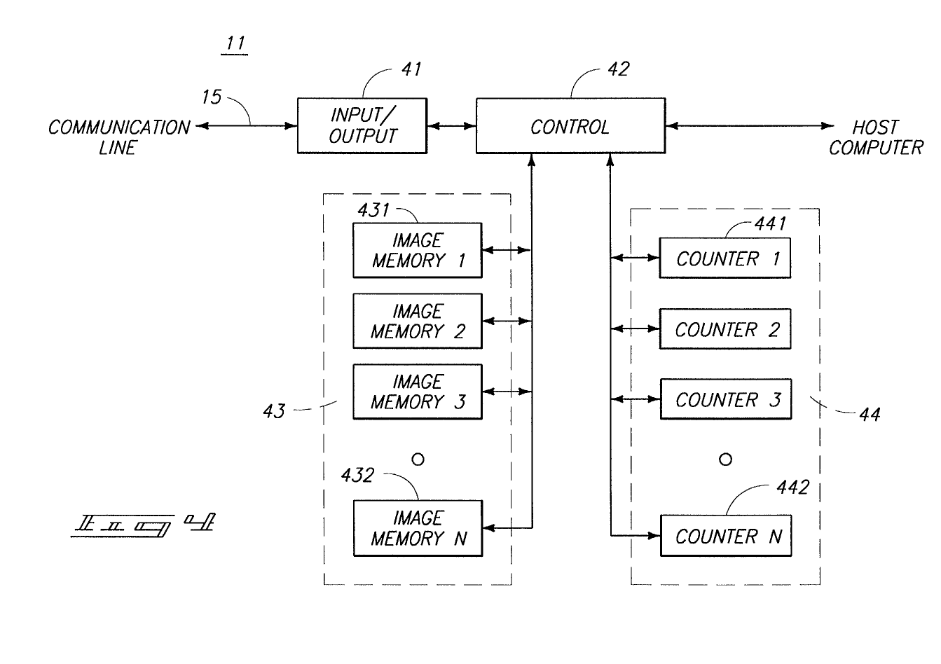

To each piece of the art information, a counter 31 is provided for counting the number of its downloads, as illustrated in FIG. 3. This counter is provided for each piece of the art information within the server 11 or host computer 10, so that when the user initiates a download of desired art information, the counter value associated with it is incremented by one. That is, the art information 22 is associated with the counter 31. The counter value is used as a basis for calculating the service fee to be paid to the provider of the art information, as described hereinbelow.

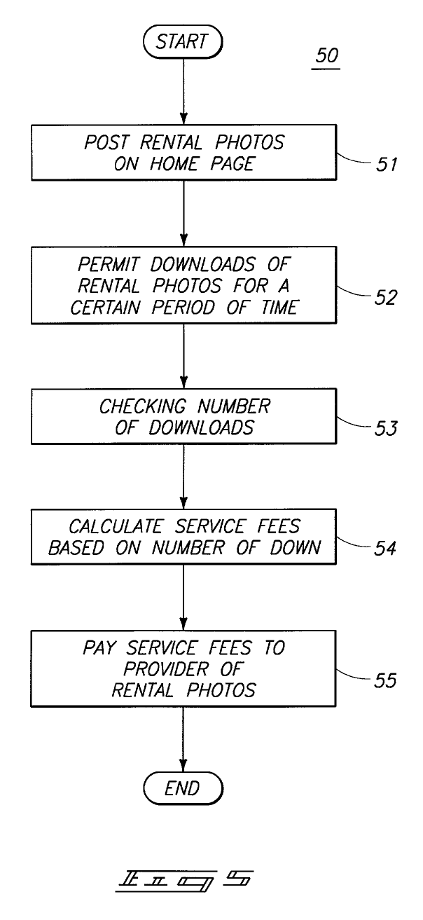

Next, the architecture within the server 11 for implementing the present invention is described. Referring to FIG. 4, a block diagram according to the present invention for storing and delivering art information is illustrated. Components related to the present invention within the server 11 are comprised of an input/output portion 41, a control portion 42, a memory portion 43, and a counter portion 44. It should be appreciated that the server 11 typically contains other components for achieving its functionality, although they are not described herein because they are not relevant to the present invention. The input/output portion 41 is connected to a communication path 15 and coupled to client computers 13 and 14. The input/output portion 41 exchanges data with the client computers; especially, from the server, home pages for rental photos are provided and rental photo data is downloaded, while download requests for rental photos and so forth are sent from the client computers. The input/output portion 41 is connected to the control portion 42, to which a received data signal is transmitted. For the signal transmitted to the control portion 42, its content is analyzed, and, according to the analysis result, a transaction on the download request is executed, for example. The control portion 42 is further connected to the memory portion 43 and counter portion 44. The memory portion 43 stores each rental photo data from image memory (1) 431 to image memory (N) 432, which is read by the control portion 42 in response to a download request from the user. The counter portion 44 is comprised of counter (1) 441 through counter (N) 442, which counts the number of downloads of a rental photo. The counter (1) 441 is associated with the image memory (1) 431, and the counter (N) 442 is associated with the image memory (N) 432. More specifically, when the rental photo data stored in the image memory (1) 431 is read, the control portion 42 increments the count value of the counter (1) 441 by one. The above-mentioned image memories and counters may be implemented by separate memory elements, although they are typically formed by magnetic memory devices, opto-magnetic memory devices, semiconductor memory devices, and so forth that are used as storage devices for computers. Art information stored in the image memory undergoes a data compression process suitable for its content before being stored therein. For example, still images and motion images undergo JPEG and MPEG compression, respectively.

The control portion 42 is further coupled to the host computer 10 to receive data and control signals required for the operation of the server 11. The data contains the art information data to be stored in the image memory, so that the art information in the image memory is updated as appropriate by the system operator. The counter value is also read by the host computer as needed, so that certain processing is performed thereon. For example, based on the counter value, the service fee for the art information to be paid to the owner of the art information is calculated. This calculation may be based on any calculation formula; the service fee may be simply proportional to the counter value, or a certain service fee may be paid when a predetermined counter value is exceeded. Furthermore, certain service fees may be paid to a predetermined number of high rankers in order of higher counter values for art information posted.

Next, how to administer the system that delivers art information according to the present invention is described. FIG. 5 shows a flow chart for describing the method for delivering art information. Prior to the delivery of art information, the operator who administers the present system sets up a home page for delivering the art information on the Internet or the i-mode service operated by NTT DoCoMo. Then, at step 51 in FIG. 5, art information to be posted on the home page (note that although it is restricted to rental photos for the sake of simplicity of explanation, art information includes various kinds of information, as described above) is recruited, and if it meets certain criteria defined by the system operator, it is allowed to be posted. For example, if a certain amount of registration fee is paid, a rental photo is posted. The rental photos are allowed to be posted and downloaded for a certain period of time, as shown at step 52. Downloading of rental photos is granted to users who have made registration with the system operator in advance. The flow proceeds to step 53, where after the certain period of time has elapsed, the number of downloads of the rental photo is determined from the counter value, and then proceeds to step 54, where the service fee for the information to be paid to the provider of the rental photos is calculated. The calculation, which may be done in various ways, as described above, is determined by the system operator. Lastly, at step 55, the service fee for the information, as determined at step 54, is paid to the provider of the rental photos. Payments may be made in any way, such as bank transfer to the bank account of the rental photo provider or personal check payment.

The rental photos from the home page described above may not necessarily be high-resolution versions, but may be of any quality enough for design prototyping. Additionally, in consideration of the time required to download a rental photo, long download times are undesirable. Furthermore, if design prototyping is conducted on a computer screen and the resulting prototype design is presented to the client, rental photos will not demand high resolution, as described above. If a prototype design that uses rental photos is adopted by the client, a request is made for delivery of high-resolution data from the owner of the rental photos. In that case, a certain service fee is paid according to a general transaction practice.

The above system has been shown by way of example for creating a design by use of rental photos, although it is not restricted to this example, as described above. For example, instead of rental photos, game software may be uploaded, so that it may be downloaded in response to a request from a user and the number of such downloads may be counted by a counter.

In addition, portrait photos showing persons' face and figure may be posted so that they may be used in a contest that determines the ranking according to the number of user downloads. In that case, business may be conducted by providing a site for posting the photos and collecting service fees incurred therefore.

As described above, according to the present invention, because art information, such as rental photos, may be posted on a home page and delivered as appropriate in response to download requests from users, convenience of the art information is improved. From the standpoint of the business operator, because the utilization of art information can be managed by counters, business operation is facilitated.

In compliance with the statute, the invention has been described in language more or less specific as to structural and methodical features. It is to be understood, however, that the invention is not limited to the specific features shown and described, since the means herein disclosed comprise preferred forms of putting the invention into effect. The invention is, therefore, claimed in any of its forms or modifications within the proper scope of the appended claims appropriately interpreted in accordance with the doctrine of equivalents.

1. A method for delivering art information by use of a telecommunication path, said method comprising the steps of:
storing digitized art information in a predetermined area of a computer;
in response to a request for downloading said art information from said computer via a telecommunication path, counting the number of said download requests as a count value by a counter associated with said art information; and
calculating a service fee for said art information, based on said count value.

2. A method for delivering art information by use of a telecommunication path according to claim 1, wherein said step of counting the number of said requests by a counter associated with said art information includes the step of counting by a counter provided in said computer.

3. A method for delivering art information by use of a telecommunication path according to claim 1, further comprising the step of delivering said art information stored in said computer via said telecommunication path, in response to a request for downloading said art information.

4. A method for delivering art information by use of a telecommunication path according to claim 1, wherein said step of storing digitized art information in a predetermined area of a computer includes the step of storing said art information which comprises still-image information, motion-image information, sound information, illustration information, or computer software including game software, or any combination thereof.

5. A method for delivering art information by use of a telecommunication path according to claim 1, wherein said step of storing digitized art information in a predetermined area of a computer includes the step of reducing the amount of said art information by a predefined information compression process.

6. A method for delivering art information by use of a telecommunication path according to claim 3, wherein said step of delivering said art information stored in said computer via said telecommunication path includes the step of delivering said art information via a wired or wireless telephone network.

7. A method for delivering art information by use of a telecommunication path according to claim 1, further comprising the step of remitting said service fee to a provider of said art information.

8. A system for delivering art information via a telecommunication path in response to a request for downloading said art information, said art information comprising digitized still-image information, motion-image information, sound information, or computer software including game software, or any combination thereof, said system comprising:
memory area for storing, in a predetermined area of a computer connected to said telecommunication path, said art information delivered from an owner of said art information;
a transmission control portion for transmitting onto said telecommunication path said art information stored in said memory area, in response to a request for downloading said art information;
a counter having a predetermined association with said art information stored in said memory area and counting the number of requests for downloading said art information; and
a calculating portion for calculating a service fee to be paid to said owner, based on the count value indicated by said counter.

9. A system according to claim 8, wherein multiple pieces of said art information are stored in said memory area, said multiple pieces of art information have counters associated with respective art information, and each counter counts how many times said art information has been downloaded.

10. A system according to claim 8, wherein said art information is delivered by use of the Internet over said telecommunication path.
